(19) United States
(12) Patent Application Publication
(10) Pub. No.: US 2012/0318979 A1
(43) Pub. Date: Dec. 20, 2012

(54) INFRA-RED SENSOR

(75) Inventor: Stephen PALLISTER, Glasgow (GB)

(73) Assignee: Thales Holdings UK Plc, Surrey (GB)

(21) Appl. No.: 13/365,059

(22) Filed: Feb. 2, 2012

(30) Foreign Application Priority Data
Feb. 2, 2011 (GB) 1101819.9

(51) Int. Cl. G01J 5/08

(52) U.S. Cl. 250/330

(57) ABSTRACT

An infra-red sensor comprising an infra-red lens, an infra-red detector and a processing and control circuit connected to the detector and arranged to provide an output infrared image signal, a heat extraction device for dissipating excess heat from the sensor, and a passive thermal distribution system comprising at least one first heat pipe linking the processing and control circuit board thermally to the heat extraction device, and at least one second heat pipe linking the lens thermally to the processing and control circuit.

### FIELD

The following relates to the thermal management of an infra-red sensor to enable it to perform over a range of ambient temperatures. The sensor may be for example a ground-based, naval or airborne Optronics sensor.

### BACKGROUND

Thermal management in Optronics equipment is usually designed around maximising heat removal at high temperatures, and supplying additional power to elevate temperatures at low temperature to allow electronics/optics/mechanics to function in sub-zero conditions.

Not only does this require additional power, but it also requires additional overheads of temperature sensors, cabling, electronics and software/firmware for closed loop feedback temperature control. These all add volume, mass and cost. Fan, connectors, electronics etc all reduce mean times between failures.

Inefficiencies in thermal heat removal at high temperatures can increase power requirements for fans, which themselves create additional power requirements and cooling loads.

Anti-icing in Optronics equipment is a particular problem (particularly for airborne equipment where it is not possible to manually de-ice the equipment) and usually involves resistive heating to increase the temperature of the device or lens in order for it to operate. Again this requires the use of power which may be at a premium in the case of airborne applications.

For some airborne applications, thermal management is a particular problem due to the external and isolated nature of the sensor positions on the airframe in order to get full 360° viewing coverage around the airframe. Sensor locations may be adjacent to a composite material and afford no thermal conduction paths. The airframe may be left to bake out on the tarmac in hot climates and reach >70° C. This would pose problems for the cryogenic detector and the electronics which have an operational limit of typically 85° C. The electronic control and processing and cryogenic cooling required for a typical IR detector consume around 45 W at high temperatures. The lens housing and chassis may be made from Titanium Alloy, to allow the lens to remain focused over the operating temperature range. Ti Alloy has a very low thermal conductance which isolates the lens from any heat generated in other parts of the equipment. The electronics may therefore be mounted to a separate chassis made e.g. from aluminum alloy which includes a rear mounted heat sink for dissipating the heat away from the sensor unit.

Furthermore, such sensors need to operate at low temperature down to −40° C., which requires that ice is prevented from forming on the front lens. Due to the wide angle nature of the lens, ice accretion on the surrounding frontal surfaces would also cause a problem, so the heat supplied has to be supplied to areas surrounding the lens to keep those free of ice as well. Ice accretion is most prevalent between temperatures of 2° C. and −20° C., so the anti-icing has to work in these conditions as a minimum.

### BRIEF DESCRIPTION OF THE DRAWINGS

FIG. 1 is a perspective view of an infra-red sensor embodying the invention, showing some of the internal parts in broken lines;

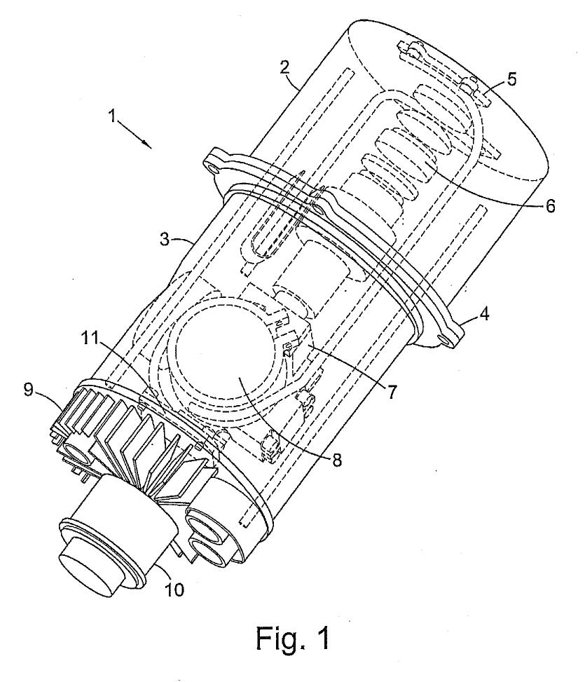

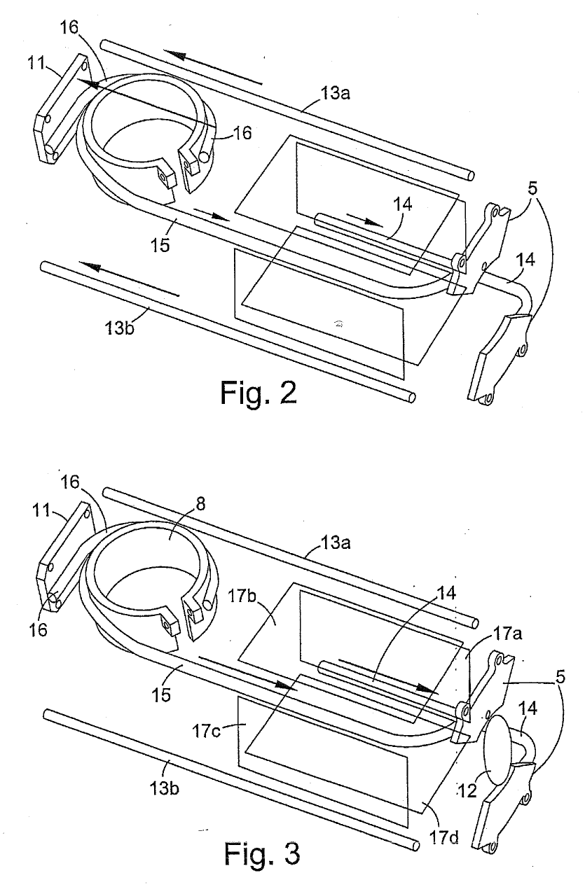

and FIGS. 2 and 3 show principal components of the infra-red sensor of FIG. 1 with reference to high temperature and low temperature operation respectively.

### DETAILED DESCRIPTION

According to one embodiment an infra-red sensor comprises an infra-red lens, an infrared detector and a processing and control circuit connected to the detector and arranged to provide an output infra-red image signal, a heat extraction device for dissipating excess heat from the sensor, and a thermal distribution system comprising at least one first heat pipe linking the processing and control circuit thermally to the heat extraction device, and at least one second heat pipe linking the lens thermally to the processing and control circuit.

Certain embodiments described herein may contribute to overcoming certain deficiencies of such prior infra-red sensors, by improving thermal management for low temperature and high temperature operation.

An infra-red sensor of a particular embodiment is shown in FIGS. 1 to 3, the sensor 1 comprising two housing components 2, 3 joined at flanges 4. An arrangement of infrared lenses 6 conveys infra-red light to an infra-red detector unit 7 housed in a vacuum container and connected thermally to a Stirling cycle cooler 8. The cooler 8 has an electric motor driving a compressor which, as is well known, pumps heat from one area to another, in this example from the infra-red detector 7 to a thermal interface 11 connected to a fin type heat sink 9 for dissipating heat outside the sensor 1. An electric motor fan 10 assists in the dissipation of heat from the fins of the heat sink 9 although this may not be needed depending on the ambient temperatures the unit has to work over and the overall thermal dissipation of the unit.

The electronic processing and control of the various components of the sensor is mounted on four circuit boards 17a, 17b, 17c and 17d within the sensor housing, and disposed around the lens arrangement 6. This processing and control circuitry controls the operation of the infra-red detector 7, which processes the image and outputs an electronic signal representative of the infra-red image. There is also control circuitry for selectively operating the cooling fan 10 if fitted, preferably by switching the fan on when the temperature of the sensor, as measured by a temperature sensing circuit (not shown), rises above a predetermined threshold temperature. Processing and control circuitry also controls the operation of the Stirling cycle cooler 8, which is switched on when it is required, either to cool the detector 7 in high temperature conditions, or to generate heat to assist in the maintenance of a sufficiently high temperature in the region of the front lens of the lens assembly 6.

As shown in FIG. 3, a Kapton tape lens heater 12 is arranged adjacent the front lens of the lens arrangement 6, to heat the lens and its surroundings in low temperature conditions, and this heater is selectively switched on by the processing and control circuitry, in response to the sensed temperature. This heater is used to augment the heat supplied by the heat pipes, and depending on environmental performance required may not be necessary.

The front lens and its surrounding area are in thermal contact with thermal interface plates 5 at the front of the sensor 1, and one of these plates is connected by a heat pipe 14 to the circuit boards 17a to 17d, for thermal management.

The circuit boards 17a to 17d are also connected, by a pair of parallel heat pipes 13a, 13b, to the heat sink 9.

The Stirling cycle cooler 8 is also connected thermally by a heat pipe 15 to one of the thermal interface plates 5, for heating the front lens arrangement when necessary using heat from the detector and heat generated by the motor and compressor. A further heat pipe 16 connects the Stirling cycle cooler 8 to the thermal interface plate 11 of the heat sink 9.

In this example, the heat pipes 14 and 15 that need to operate even in low temperature conditions are preferably copper-methanol pipes. The other heat pipes 13a, 13b and 16 are preferably copper-water heat pipes, which give more efficient thermal transfer than the copper-methanol heat pipes, and which have the advantage of becoming inoperative in freezing conditions.

The heat pipes are brazed onto the collars or plates 5, 11 etc., in order to maximise heat transfer. Although not shown, the portion of the housing 2 that surrounds the front lens at the front of the sensor 1 is thermally conductive and is connected thermally to the plates 5. Although in this example each heat pipe 14, 15 is connected only to a respective one of the plates 5, alternative arrangements are possible.

The operation of the sensor in high temperature conditions, such as between 0° C. and 85° C., will now be described with reference particularly to FIG. 2. The copper-methanol heat pipes 14, 15, because of their ability to function at temperatures up to 125° C., are still functioning satisfactorily, moving heat passively from warmer to cooler areas. Accordingly, they assist in dissipating heat from the Stirling cycle cooler, and from the circuit boards, to the front region of the sensor 1 surrounding the lens. The Stirling cycle cooler 8 is driven by its motor to cool the infra-red detector unit 7, and to dissipate heat through the heat sink 9 by way of the plate 11. The copper-water heat pipes 13a, 13b convey heat from the circuit boards 17a to 17d to the heat sink 9. The rear fan 10 is switched on at temperatures above 5° C., to enhance the thermal convection and heat dissipation at the rear of the unit.

In this example, the copper-water heat pipes are typically of 4 mm diameter, to provide sufficient thermal transfer capability to handle 13 Watts from the detector 7 and 7.5 Watts from each of the four circuit boards 17a to 17d, as well as heat from the cooling engine motor and compressor.

Low temperature operation is illustrated particularly in FIG. 3. Since the water filling the heat pipes 13a, 13b and 16 has a higher freezing point than the liquid of the other heat pipes which are copper-methanol, these heat pipes become passively non-operational in accordance with their temperature being below 0° C. In low temperatures, for example −75° C. to 0° C., the copper-water pipes are frozen and cease to function, decreasing the removal of heat to the rear of the unit, and maximising thermal heat movement to the front lens. The heat pipe 14 moves heat from the circuit boards to one of the plates 5, while the heat pipe 15 moves heat from the cooler 8, which can be left on for this purpose, to the other of the plates 5. The lens heater 12 is also switched on.

In this example, the copper-methanol heat pipes are 6 mm in diameter, for transporting 13 Watts from the cooling engine 8 and 15 Watts from each pair of circuit boards 17a to 17d. These heat pipes are embedded into the skeleton chassis of the sensor 1 and are routed past the boards to emerge at each end.

Not every component of the sensor of FIGS. 1 to 3 is essential In particular, the electric fan 10, the Stirling cycle cooler 8 and the tape lens heater 12 are optional.

The thermal distribution system of certain embodiments may operate passively, and so may not generate any heat itself nor require any power input. It can cool the processing and control circuit board in high temperature conditions, and it can maintain a satisfactorily high temperature of the lens and lens surround in sub-zero conditions. It also can be more reliable than the prior active systems.

The use of waste heat generated by the electronics within the unit for anti-icing reduces the need for additional power for heating during low temperature operation. The increased efficiency of the cooling system at high temperature improves the performance of the sensor to allow operation at more extreme temperatures, or without external fans. Both of these measures will reduce the burden on host platform power supplies.

For higher thermal dissipation during high temperature operation, an additional heat pipe (not shown) may be mounted externally of the sensor in place of the rear heat sink 9. This is ideally a loop heat pipe for moving the heat over substantial distances with low losses. A looped heat pipe is one that is able to work in any orientation. It can move heat larger distances than conventional heat pipes with less loss. This is useful as heat movement is driven by the temperature differential, so high losses reduce the differential and reduce the amount of heat that can be removed. Moving it over larger distances mean there is a better chance to remove the heat to an external surface or a larger heat sink in a more advantageous location for heat removal. http://www.thermacore.com/products/loop-heat-pipes-and-loop-devices.aspx

Different working fluids of the heat pipes may of course be selected to suit the operating conditions and the particular application of the sensor.

While certain embodiments have been described, these embodiments have been provided by way of example only, and are not included to limit the scope of the invention. Indeed, the novel devices described herein may be embodied in a variety of other forms; furthermore, various omissions, substitutions and changes in the form of the devices described herein may be made without departing from the spirit of the invention. The accompanying claims and their equivalents are intended to cover such forms as would fall within the scope and spirit of the invention.

1. An infra-red sensor comprising an infra-red lens, an infra-red detector and a processing and control circuit connected to the detector and arranged to provide an output infra-red image signal, a heat extraction device for dissipating excess heat from the sensor, and a passive thermal distribution system comprising at least one first heat pipe linking the processing and control circuit board thermally to the heat extraction device, and at least one second heat pipe linking the lens thermally to the processing and control circuit.

2. A sensor according to claim 1, comprising a Stirling cycle cooler arranged to pump heat from the detector to the heat extraction device.

3. A sensor according to claim 2, in which the Stirling cycle cooler is connected thermally to the infra-red lens by a third heat pipe of the thermal distribution system, for heating the lens with waste heat from the Stirling cycle cooler for anti-icing purposes.

4. A sensor according to claim 1, comprising an electric heater adjacent the infrared lens for heating it selectively.

5. A sensor according to claim 4, in which the processing and control circuit is arranged to monitor the temperature of the infra-red sensor and to switch on the electric heater when the temperature is below a predetermined threshold to augment the passive heating supplied.

6. A sensor according to claim 1, in which the first heat pipe or pipes are filled with a liquid whose freezing point is higher than that of the second heat pipe or pipes.

7. A sensor according to claim 1, in which the first heat pipe or pipes is filled with water.

8. A sensor according to claim 1, in which the second heat pipe or pipes is filled with methanol.

9. A sensor according to claim 1, in which the heat extraction device comprises a heat sink.

10. A sensor according to claim 1, in which the heat extraction device comprises an electric fan to provide additional cooling.

11. A sensor according to claim 10, in which the processing and control circuit is arranged to monitor the temperature of the infra-red sensor and to switch the electric fan on only when the temperature is above a predetermined threshold.

12. A sensor according to claim 1, in which the heat extraction device comprises a ‘Looped’ heat pipe.
